(19) United States
(12) Patent Application Publication
(10) Pub. No.: US 2010/0210164 A1
(43) Pub. Date: Aug. 19, 2010

(54) Strengthening Structure for Waterproof Fabric

(76) Inventor: Tony Shih, Taichung County (TW)

Correspondence Address: Dr. BANGER SHIA;Patent Office of Bang Shia, 102 Lindencrest Ct., Sugar Land, TX, 77479-5201, US

(21) Appl. No.: 12/371,600

(22) Filed: Feb. 14, 2009

(51) Int. Cl. B32B 5/26

(52) U.S. Cl. 442/381

(57) ABSTRACT

A strengthening structure for waterproof fabric comprises one elastic and waterproof fabric or two elastic and waterproof fabrics, an elastic adhesive member is bonded to the bonding seam between the fabrics, and waterproof and elastic first and second auxiliary pieces are boned to both sides of the bonding seam. Thereby, such a structure is improved in tensile and waterproof properties.

### BACKGROUND OF THE INVENTION

1. Field of the Invention

The present invention relates to a strengthening structure for waterproof fabric, and more particularly to a strengthening structure for waterproof fabric which can be applied to diving suits, fishing trousers or other similar things.

2. Description of the Prior Art

Waterproof fabric can be used to make diving suits or fishing trousers, and such diving suits or fishing trousers must have a good waterproof performance since they are in direct contact with water or even should resist a relatively great water pressure.

However, diving suits or fishing trousers are usually made by bonding pieces of fabric together, and if they are not bonded closely, the leakage problem will be caused.

Moreover, when the user puts on the diving suits or fishing trousers made by the above-mentioned fabric, the fabric will be stretched or expanded, which will be likely to cause leakage at the bonding portion.

The present invention has arisen to mitigate and/or obviate the afore-described disadvantages.

### SUMMARY OF THE INVENTION

The primary objective of the present invention is to provide a strengthening structure for waterproof fabric which is improved in tensile and waterproof properties.

To achieve the objective of the present invention, the strengthening structure for waterproof fabric in accordance with a first embodiment of the present invention comprises a first fabric having a first surface, an opposite second surface and a first end surface located between the first and second surfaces, a second fabric having a first surface, an opposite second surface and a second end surface located between the first and second surfaces, and an adhesive member. The adhesive member is disposed between the first fabric and the second fabric and is used to bond the first fabric to the second fabric.

The strengthening structure for waterproof fabric in accordance with a second embodiment of the present invention comprises a fabric having a first surface, a second surface opposite the first surface, a first end surface and an opposite second end surface located between the first surface and the second surface. The adhesive member is used to bond the first end surface of the fabric to the second end surface.

Since the fabrics and adhesive member are elastic, the present invention is improved in tensile and expansible properties. In addition, elastic auxiliary pieces can also be integrally bonded to the bonding seam between the fabrics in a seamless manner, which can effectively improve the waterproof and elastic properties, further, the problem that the seam caused discomfort when pressing against the wear's body can be solved, so as to improve the wearing comfort.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a strengthening structure for waterproof fabric in accordance with a first embodiment of the present invention;

FIG. 2 is an illustrative view showing the strengthening structure for waterproof fabric in accordance with the first embodiment of the present invention;

FIG. 3 is an illustrative view showing the strengthening structure for waterproof fabric in accordance with the first embodiment of the present invention; and

FIG. 4 is an illustrative view showing the strengthening structure for waterproof fabric in accordance with a second embodiment of the present invention.

### DETAILED DESCRIPTION OF THE PREFERRED EMBODIMENTS

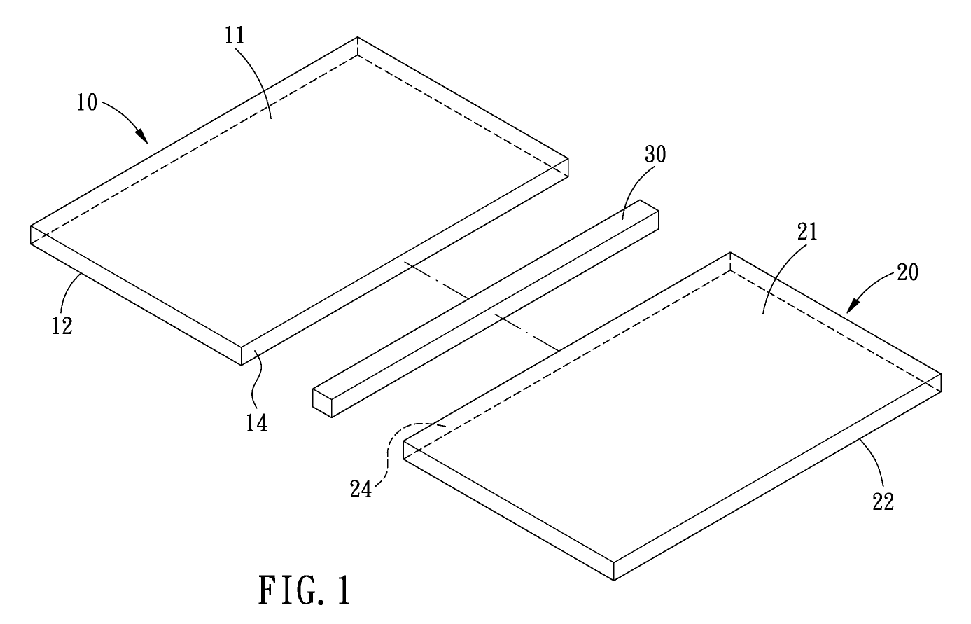

Referring to FIG. 1, a strengthening structure for waterproof fabric in accordance with a first embodiment of the present invention is a structure for bonding a first fabric 10 and a second fabric 20 that are elastic and waterproof.

The first fabric 10 comprises a first surface 11 and a second surface 12, and a first end surface 14 is located between the first surface 11 and the second surface 12.

The second fabric 20 comprises a first surface 21 and a second surface 22, and a second end surface 24 is located between the first surface 21 and the second surface 22.

An elastic adhesive member 30 is disposed between the first fabric 10 and the second fabric 20.

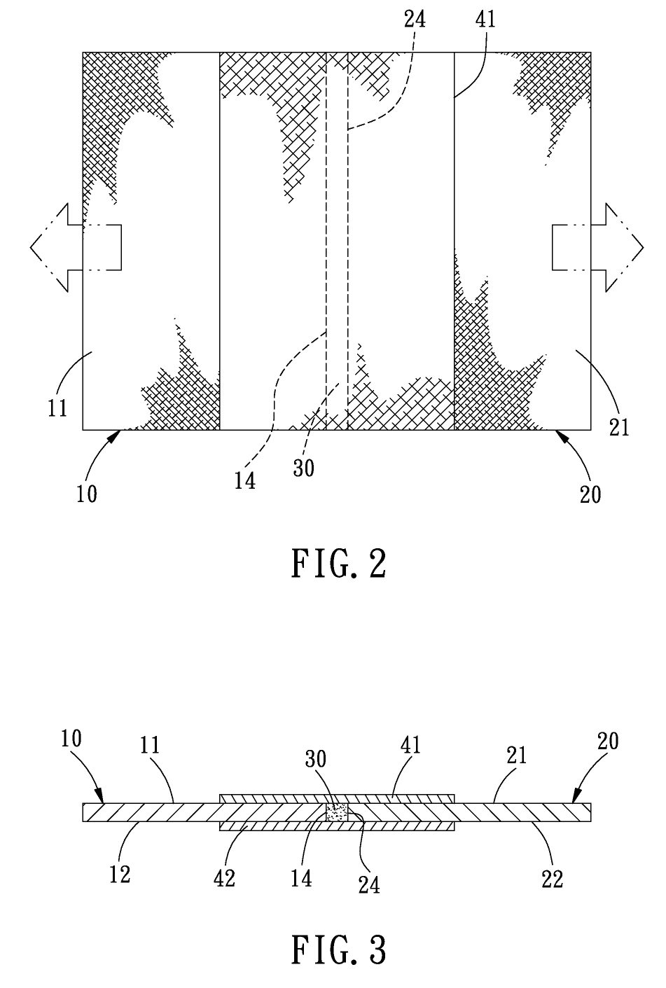

Referring to FIGS. 2 and 3, the adhesive member 30 is used to bond the first end surface 14 to the second end surface 24. A first auxiliary piece 41 is bonded to the first surface 11 of the first fabric 10, the adhesive member 30 and the first surface 21 of the second fabric 20. The first auxiliary piece 41 is made of waterproof and elastic fabric. Similarly, a second auxiliary piece 42 is bonded to the second surface 12 of the first fabric 10, the adhesive member 30 and the second surface 22 of the second fabric 20. The second auxiliary piece 42 is also made of waterproof and elastic fabric.

The first and second fabrics 10 and 20 are made of nylon. The first and second auxiliary pieces 41 and 42 are made of tape or plutonium (Pu). The adhesive member 30 is made of rubber or synthetic resin.

Since the adhesive member 30 is elastic, it can improve the tensile or expansible properties of the above-mentioned fabrics when the fabrics are stretched. In addition, the first and second auxiliary pieces 41 and 42 cover the bonding seam between the first and second fabrics 10 and 20, which can prevent water from permeating through the area where the adhesive member 30 is located. Therefore, the present invention is improved in tensile and waterproof properties.

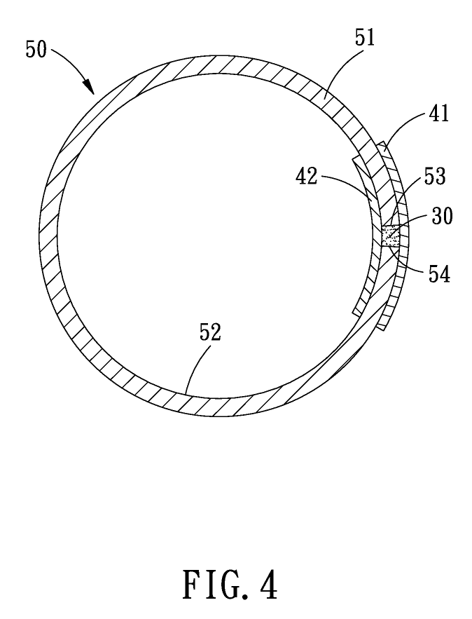

Referring to FIG. 4, the strengthening structure for waterproof fabric in accordance with a second embodiment of the present invention, wherein a fabric 50 comprises a first surface 51, a second surface 52 opposite the first surface 51, a first end surface 53 and an opposite second end surface 54 located between the first surface 51 and the second surface 52.

The adhesive member 30 is used to bond the first end surface 53 to the second end surface 54 in such a manner that the fabric 50 will have a better anti-expansion effect.

Moreover, the first and second auxiliary pieces 41 and 42 can be bonded to the adhesive member 30 and each have both sides extended to the first and second surfaces 51 and 52 of the fabric 50. In other words, the first and second auxiliary pieces 41 and 42 cover the adhesive member 30 and parts of the first and second surfaces 51 and 52 located at both sides of the adhesive member 30.

The first and second auxiliary pieces 41 and 42 can be heated to melt the adhesive agent on their surfaces so that they can be bonded to the respective surfaces of the fabric 50, and after the melted adhesive agent cools down, the first and second auxiliary pieces 41 and 42 can be integrally bonded together with the respective surfaces of the fabric 50.

The second embodiment is also improved in tensile and waterproof properties.

While we have shown and described various embodiments in accordance with the present invention, it should be clear to those skilled in the art that further embodiments may be made without departing from the scope of the present invention.

What is claimed is:

1. A strengthening structure for waterproof fabric, comprising:
a first fabric having a first surface, an opposite second surface, a first end surface located between the first and second surfaces of the first fabric;
a second fabric having a first surface, an opposite second surface, a second end surface located between the first and second surfaces of the second fabric;
an adhesive member being disposed between the first fabric and the second fabric and used to bond the first fabric to the second fabric; and
at least one auxiliary piece being bonded to the first and second surfaces of the first and second fabrics and the adhesive member.

2. The strengthening structure for waterproof fabric as claimed in claim 1, wherein the adhesive member is disposed between the first end surface and the second end surface.

3. The strengthening structure for waterproof fabric as claimed in claim 1, wherein the adhesive member is elastic.

4. The strengthening structure for waterproof fabric as claimed in claim 1 further comprising a first auxiliary piece, wherein the first auxiliary piece is bonded to the first surface of the first fabric, the first surface of the second fabric and the adhesive member.

5. The strengthening structure for waterproof fabric as claimed in claim 1 further comprising a second auxiliary piece, wherein the second auxiliary piece is bonded to the second surface of the first fabric, the second surface of the second fabric and the adhesive member.

6. The strengthening structure for waterproof fabric as claimed in claim 1, wherein the first and second fabrics are elastic.

7. The strengthening structure for waterproof fabric as claimed in claim 4, wherein the first auxiliary piece is elastic.

8. The strengthening structure for waterproof fabric as claimed in claim 5, wherein the second auxiliary piece is elastic.

9. A strengthening structure for waterproof fabric, comprising:
a fabric having a first surface, an opposite second surface, a first end surface and a second end surface located between the first surface and the second surface;
an adhesive member being used to bond the first end surface of the fabric to the second end surface; and
at least one auxiliary piece being bonded to the first and second surfaces of the fabric and the adhesive member.

10. The strengthening structure for waterproof fabric as claimed in claim 9, wherein the adhesive member is elastic.

11. The strengthening structure for waterproof fabric as claimed in claim 9 further comprising a first auxiliary piece, wherein the first auxiliary piece is bonded to the first surface and the adhesive member, and covers parts of the first surface located at both sides of the adhesive member.

12. The strengthening structure for waterproof fabric as claimed in claim 11, wherein the first auxiliary piece is elastic.

13. The strengthening structure for waterproof fabric as claimed in claim 9 further comprising a second auxiliary piece, wherein the second auxiliary piece is bonded to the second surface and the adhesive member, and covers parts of the second surface located at both sides of the adhesive member.

14. The strengthening structure for waterproof fabric as claimed in claim 13, wherein the second auxiliary piece is elastic.
